(19) United States
(12) Patent Application Publication
(10) Pub. No.: US 2025/0024333 A1
(43) Pub. Date: Jan. 16, 2025

(54) DETERMINATION AND CONFIGURATION OF QUALITY OF SERVICE PARAMETERS DURING HANDOVER

(71) Applicant: T-Mobile USA, Inc., Bellevue, WA (US)

(72) Inventors: Praveen Singaram Muthukumar, Lawrenceville, NJ (US); Kunal Prakash Barawkar, Bothell, WA (US)

(21) Appl. No.: 18/219,952

(22) Filed: Jul. 10, 2023

(51) Int. Cl. H04W 36/00; H04W 36/14

(52) U.S. Cl. CPC H04W 36/0044; H04W 36/142

(57) ABSTRACT

Systems and methods for determining QoS parameters during handover for a wireless device from one network and/or technology to another include establishing the device on a first network or technology and configuring a communications session on the first network or technology using QoS parameters. During handover, the current QoS parameters are evaluated by the recipient second network or technology to determine if updated QoS parameters are required. If so, the updated QoS parameters are acquired and a communications session is established using such parameters on the second network or technology. Otherwise, default QoS parameters and/or QoS parameters from the first network or technology are used by the second network or technology to establish a communications session for the device.

### BACKGROUND

As the development of modern wireless communications technologies has progressed, the number of wireless communications devices (e.g., user devices such as mobile telephones, smartphones, tablets, laptops, etc.) and the networks to support them have increased greatly. A variety of wireless communications technologies are now available across the various wireless communications networks currently supporting user devices. Many wireless communications networks even support a variety of wireless communications technologies within the same network. This allows such networks to support user equipment (UE) of varying capabilities. Likewise, modern UEs may be configured to support various types of wireless communications technologies. For example, many UEs may support communications using multiple 3GPP standards, such as both Long Term Evolution (LTE) (e.g., 4G LTE) and New Radio (NR) (e.g., 5G NR).

To ensure a particular level of service for a customer, an operator of a wireless communications network may assign a particular quality of service (QoS) to the customer (e.g., for the customers' UE(s)) by configuring one or more QoS parameters and/or settings in the wireless communications network. In many instances, the QoS configuration in a network for a particular customer may be the same or substantially similar across various wireless communications technologies. For example, the QoS configuration for a particular customer may be the same or substantially similar on both 4G and 5G components of a wireless communications network. However, some customers may request (e.g., subscribe) to different levels of QoS for different technologies and/or may have included in their subscriptions automated changes of QoS (e.g., QoS parameters and/or settings) based on various conditions. For example, a business customer or a government agency may be configured for a higher level or type of QoS for particular technologies and/or conditions than that configured for a typical (e.g., non-business or consumer-level) customer.

Because a subset of customers may require different QoS settings and/or parameters based on the wireless communications technologies in use and/or conditions present while other customers may have substantially the same QoS settings and/or parameters (or no QoS settings and/or parameters) regardless of wireless communications technologies and/or conditions, it may be challenging to ensure that the components of a wireless communications network are properly configured to provide each type of customer the expected level of service, especially when a customer's device undergoes handover between components operating with different wireless communications technologies.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communications network environment in which systems and methods for determination and configuration of quality of service parameters during handover may be implemented, in accordance with examples of the disclosure.

FIG. 2 is a schematic diagram of illustrative functions and communications that may be implemented in a wireless communications network in which systems and methods for determination and configuration of quality of service parameters during handover may be implemented, in accordance with examples of the disclosure.

FIG. 3 is a schematic diagram of illustrative functions and communications that may be implemented in a wireless communications network in which systems and methods for determination and configuration of quality of service parameters during handover may be implemented, in accordance with examples of the disclosure.

FIG. 4 is a flow diagram of an illustrative process for performing determination and configuration of quality of service parameters in a 4G network environment, in accordance with examples of the disclosure.

FIG. 5 is a flow diagram of an illustrative process for performing determination and configuration of quality of service parameters for handover from a 4G network environment to a 5G network environment, in accordance with examples of the disclosure.

FIG. 6 is a schematic diagram of illustrative components in an example user device that is configured for interacting with a wireless communications network that implements determinations and configurations of quality of service parameters during handover, in accordance with examples of the disclosure.

FIG. 7 is a schematic diagram of illustrative components in an example computing device that is configured for performing one or more aspects of determination and configuration of quality of service parameters during handover, in accordance with examples of the disclosure.

### DETAILED DESCRIPTION

### Overview

This disclosure is directed in part to systems and techniques for determining quality of service (QoS) parameters and settings for wireless communications networks and other networks that perform wireless device registration and/or handovers between wireless communications networks and wireless communications technology types. Such networks include any networks that may facilitate wireless communications services for one or more wireless communications devices. Such networks include networks that support one or more 3GPP standards, including, but not limited to, Long Term Evolution (LTE) networks (e.g., 4G LTE networks implementing any variation of 4G LTE technology (may be referred to herein as “4G”)) and New Radio (NR) networks (e.g., 5G NR networks implementing any variation of 5G NR technology (may be referred to herein as “5G”)). However, the disclosed systems and techniques may be applicable in any network or system in which a user device may request and receive access to communicate with one or more networks using any wireless communications technology and may subsequently be transferred (“handed over”) to another network or wireless communications technology type.

A wireless user device (e.g., mobile telephone, smartphone, user equipment (UE), etc.) may wirelessly communicate with a base station (e.g., gNodeB, eNodeB, NodeB, base transceiver station (BTS), etc.) configured at a first wireless communications network to request wireless communications services, such as a packet data communication session between the user device and a data network (e.g., the Internet, an IP multimedia system or subsystem (IMS), etc.). Various operations may be performed by the first wireless communications network's components, devices, and/or functions to obtain or otherwise establish the requested services for the wireless user device. Such operations may include registering the device at the various systems and functions needed to provide the requested services and establishing QoS parameters and/or settings for communications associated with the device. The device may then establish a communications session with a remote device using these initially acquired and configured resources.

At some point during this communications session, the device may be “handed over” to a second wireless communications network for any of a variety of reasons. (Note that this second wireless communications network may be operated by the same operator as the first wireless communications network and may include components that share physical resources with components of the first wireless communications network.) For example, the initial service with the first wireless communications network may become lower quality than that available from the second wireless communications network due to network congestion, geographical movement of the device (e.g., farther away from a base station for the first wireless communications network and closer to a base station for the second wireless communications network), other technical issues, etc. During such a handover, operations may be performed by the second wireless communications network's associated components, devices, and/or functions to maintain or otherwise transfer communications services for the wireless user device to the second wireless communications network while maintaining communication continuity by, for example, maintaining or seamlessly transitioning the established communications sessions from the first wireless communications network to the second wireless communications network.

Because this handover process is a continuation of a previously established access and an existing communications session, the configurations at the second wireless communications network may be the same or substantially similar to those that were used at the first wireless communications network. This may include QoS settings and parameters that may be replicated at the second wireless communications network based on the configuration at the first wireless communications network rather than performing QoS parameter determination operations at the second wireless communications network. Such QoS determination operations and the related control signaling may be relatively resource intensive, especially where the quantity of handovers performed between networks may be large, as may the be case for wireless providers with large numbers of customers and/or that support large numbers of wireless communications devices.

However, there may be a subset of customers and/or devices that have different configurations on different networks and/or for different wireless communications technologies. For example, particular devices may be associated with elevated priority accounts and/or customers that may have different QoS requirements, settings, and/or parameters based on the supporting network and/or wireless network technology in use. Such elevated priority accounts and/or customers may be those associated with business-class services, emergency and/or governmental agencies, wireless priority service (WPS), etc.

In current systems, there is no means for determining that a device has different QoS requirements during a handover from a first network to a second network (or from a first technology to a second technology) unless such a determination is made by the second network (or technology) for every device that is handed over to it. However, performing such determinations for every device handed over is inefficient and a poor use of resources because the vast majority of devices handed over will have the same QoS requirements regardless of network or technology.

To address this issue of ensuring that components of a wireless communications network are properly configured for QoS for an elevated priority device without requiring a determination of QoS parameters and setting for every device handed over to such a network, the disclosed systems and methods facilitate the interaction of a 5G session management function (SMF) and a 5G unified data management (UDM) function to determine (e.g., 5G) QoS parameters for the elevated priority device based on particular (e.g., 4G) QoS profile information.

In various examples, during account creation and/or device provisioning, QoS parameters may be established for a user device (e.g., UE). A typical UE may be assigned the same QoS parameters (e.g., one or more QoS class identifier (QCI—may be referred to as a 5G QoS identifier or “5QI” for 5G components and networks) parameters and one or more allocation and retention priority (ARP) parameters) in both 4G and 5G networks and/or for use with both 4G and 5G components. However, an elevated priority UE may be assigned different parameters for different networks and/or technologies. For instance, an elevated priority UE may be assigned a different QCI value for 5G than for 4G, while retaining the same ARP value for both networks and technologies. Note that, while there may be overlap in the available QCI/5QI values for 4G and 5G, there may also be 5G QCI values (e.g., 5QI values) that are not supported in 4G and 4G QCI values that are not supported in 5G.

The QoS values assigned to a UE (e.g., both standard and elevated priority UEs) may be configured at particular 4G and 5G components during device provisioning. For example, 4G QoS values, including ARP and QCI, may be configured at a 4G Home Subscriber Server (HSS) when the device is provisioned in the 4G network. Likewise, 5G QoS values, including ARP and QCI (5QI), may be configured at a 5G UDM when the device is provisioned in the 5G network. For a standard priority or typical consumer-level service UE, the QoS parameters may be the same in both the UDM and HSS. However, for an elevated priority UE, the QoS parameters may differ between the UDM and HSS. For example, a standard priority UE may be configured with an ARP value of xₛ (e.g., selected from 8 and 9) and a QCI value of yₛ (e.g., selected from 1-9) at both a UDM and an HSS. An elevated priority UE, on the other hand, may be configured with an ARP value of xₑ (e.g., selected from 2-4) and a QCI value of yₑ (e.g., selected from 65 and 67) at an HSS and the same ARP value of xₑ, but a different QCI value of zₑ (e.g., selected from 82-86) at a UDM.

An elevated priority UE may register with a first wireless communications network that may be a 4G network (e.g., that may include components and systems configured to implement 4G wireless communications technologies) via a 4G eNodeB base station configured at the 4G network. The registration request received by the eNodeB may be relayed to a 4G mobility management entity (MME) or may otherwise cause the eNodeB to generate a request for network access transmitted to the MME. In response to this request for access to the 4G network, the MME may request registration and/or network access data from a 4G HSS. The requested registration and/or network access data may include QoS data, such as 4G QoS parameters (e.g., ARP and QCI) and/or settings that may be associated with the UE as configured at the HSS (e.g., based on a UE identifier, account identifier, customer identifier, etc. at the HSS). The HSS may provide this information to the MME.

The MME may use the information associated with the UE and received from the HSS to configure, or cause the configuration of, various components of the 4G network to support communications between the UE and one or more remote devices. In particular, the MME may provide QoS information for the UE to one or more 4G serving gateway control plane functions (SGW-Cs) and/or one or more 4G packet data network gateway control plane functions (PGW-Cs). These PGW-Cs and/or SGW-Cs may use this information to control and/or configure one or more serving gateway user plane functions (SGW-Us) and/or one or more 4G packet data network gateway control plane functions (PGW-Us) to facilitate communications sessions between the UE and one or more remote device, such as one or more devices or systems accessible at an IMS and/to vie the Internet.

The UE may establish (e.g., request establishment of) a communications session (e.g., a packet data network (PDN) connection or session) with one or more remote devices using the 4G network. For example, the UE may establish a voice call or a data communications session with another device. This session may be set up and facilitated based on the 4G QoS settings and/or parameters determined during the registration operations performed to register the UE with the 4G network. For example, the PGW-Us and/or SGW-Us may route user data packets associated with the communications session based on the QoS configuration (e.g., ARP and QCI) associated with the UE (e.g., based on a UE identifier or address, a using a tunnel associated with the UE and/or based on the QoS configuration, etc.).

In examples, to facilitate such a communications session, a bearer or tunnel (e.g., a 4G Evolved Packet System (EPS) bearer) may be established between the UE and a PGW-U that connects to the IMS or Internet. The determined QoS settings and/or parameters for the UE may be used to configure this bearer. In examples, along with or instead of ARP and QCI, a Guaranteed Bit Rate (GBR) (for uplink and/or downlink), a Maximum Bit Rate (MBR) (for uplink and/or downlink), and/or any other 4G QoS parameters may be used to configure this bearer.

At some point during the established 4G communications session, the UE and/or a network component may initiate a handover from the first, 4G network, to a second wireless communications network that may be a 5G network (e.g., that may include components and systems configured to implement 5G wireless communications technologies). For example, the UE may request handover to a 5G gNodeB base station configured at the 5G network via the 4G eNodeB configured at the 4G network with which it is currently communicating. The UE may perform this operation in response to detecting the 5G gNodeB and/or in response to determining that connectivity characteristics associated with the 5G gNodeB are superior to those associated with the 4G eNodeB (e.g., available bandwidth, potential throughput, congestion, etc.).

The eNodeB at the 4G network receiving this handover request from the UE may forward the request to the 4G MME and/or transmit a request to the 4G MME to initiate handover of the UE to the 5G network. This request may include information that identifies the UE, such as a UE identifier. The request may also include data indicating the currently operational communications session (e.g., tunnel, bearer, etc.), the 5G network and/or one or more components configured therein, and/or any related information (e.g., QoS profile or data associated with the currently operational communications session, such as ARP and/or QCI data). Alternatively, the MME may use the UE identifier and/or other data in the handover request to determine such session, QoS, and/or related data. For example, the handover request sent to the MME may include information that may allow the MME to identify the appropriate access and mobility management function (AMF) at the 5G network. The MME may then transmit or relay the handover request and/or a corresponding relocation request to the AMF. The MME may include QoS information for the UE in the handover request sent to the AMF, such as ARP data for the UE.

The AMF may configure or communicate with one or more 5G SMFs to establish a 5G communications service using the information associated with the handover or relocation request. The SMF(s) may interact with one or more user plane functions (UPFs) to establish a 5G communications session to be used to continue the user communications that were or are currently being facilitated using the 4G communications session on the 4G network. In examples, to facilitate such a 5G communications session, an SMF may configure or otherwise establish a bearer or tunnel (e.g., a 5G flow) between a gNodeB with which the UE will be communicating and a UPF that connects to the IMS or Internet using a QoS profile. The QoS profile provided by the MME to the AMF and/or otherwise indicated by the handover or relocation request may typically be used to configure this flow. Alternatively, a standard or default QoS profile may be used to configure this flow for typical UEs. However, for elevated priority UEs, a different QoS profile and/or different parameters (e.g., different QCI) may be used for 5G flows than 4G bearers.

In various examples, an SMF may evaluate one or more of the QoS parameters associated with the handover request to determine whether to obtain one or more updated 5G QoS parameters for the UE, for example, specifically for the 5G flow to be used for the migrating communications session. If one or more QoS parameters are associated with a requirement for updated QoS parameters, the SMF may then query a UDM for one or more 5G QoS parameters associated with the UE and/or its communications session on the 5G network. The UDM may have stored such 5G QoS data for the UE based on the initial provisioning or other prior network component configurations for the UE.

For example, the SMF may determine whether the ARP value associated with the handover is within a set of one or more ARP values associated with an elevated-priority device or service. In particular examples, ARP values of 2, 3, and/or 4 may be associated with elevated priority service, while ARP values of 8 and/or 9 may be associated with standard priority service. In such examples, the SMF may, upon determining that the handover has an associated ARP value of 2, 3, and/or 4, query the UDM for 5G QoS parameters for the UE and/or its associated communications session. In some such examples, the SMF may query the UDM for any available QoS parameters for the UE and/or its associated communications session, while in other examples, the SMF may query the UDM for particular QoS parameters for the UE and/or its associated communications session, such a QCI/5QI.

If the SMF determines and acquires one or more updated QoS parameters, the SMF may then configure the 5G flow for the communications session using these updated one or more parameters. Otherwise, if the SMF determines that there is no requirement to determine updated QoS parameters (e.g., based on the ARP value, such as an ARP value of 8 or 9), the SMF may configure the 5G flow for the communications session using the parameters associated with the handover and/or standard service parameters (e.g., default QoS parameters for the 5G network) without interacting with the UDM, thereby preventing unnecessary control signaling within the 5G network.

By facilitating the use of one or more known QoS parameters to determine whether to initiate control signaling in the network to acquire updated QoS parameters in handover operations, the systems and methods described herein provide more efficient communications session handover operations and reduced resource utilization. By limiting the signaling used to request QoS data for handover operations to those associated with elevated priority devices and services, control signaling is reduced and resources are preserved for more essential operations. For example, the methods and systems described herein may be more efficient and/or more robust than conventional techniques, as they may reduce the use of resources by preventing QoS data queries and acquisition for all handovers, while performing such QoS data queries and acquisition for UEs and session that are most likely to benefit from such operations. That is, the methods and systems described herein provide a technological improvement over existing handover operations and processes by facilitating proper QoS configurations for elevated priority UEs and sessions while preventing the use of resources used to determine updated QoS configurations for UEs and sessions that will not benefit from them. In addition to improving the efficiency of network and device resource utilization, the systems and methods described herein can provide more robust systems by, for example, making more efficient use of network devices by reducing unnecessary and/or unproductive control signaling and processing associated with acquiring updated QoS data when it is not beneficial or useful, thereby freeing network and device resources for more productive operations.

Illustrative environments, signal flows, and techniques for implementing systems and methods for the determination and configuration of QoS parameters during handover are described below. However, the described systems and techniques may be implemented in other environments.

### Illustrative System Architecture

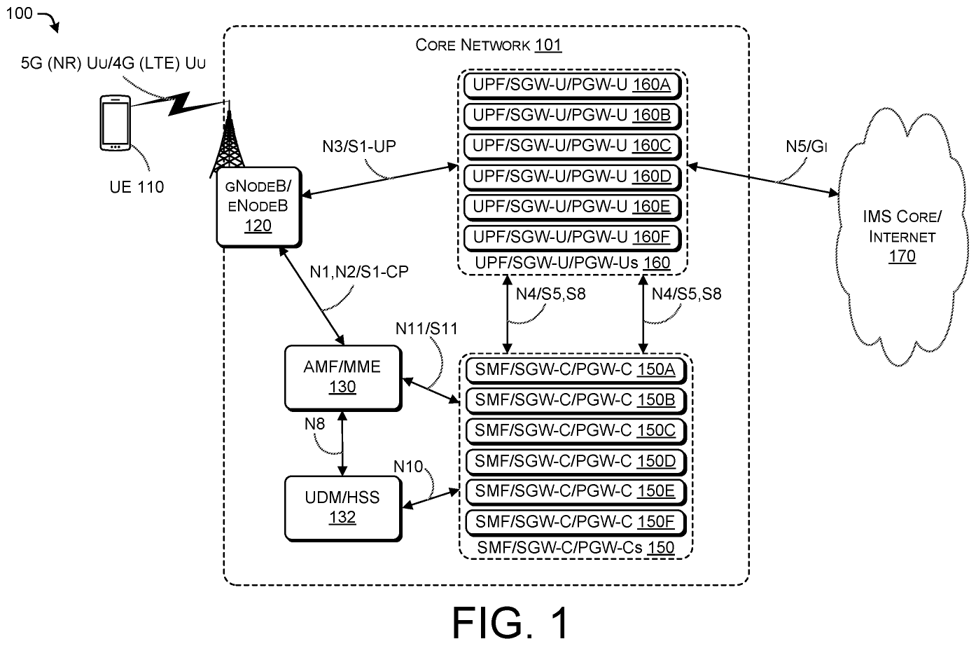

FIG. 1 is a schematic diagram of an illustrative wireless network environment 100 in which the disclosed systems and techniques may be implemented. A core network 101 of a wireless communications network may be configured in the environment 100. In examples, the core network 101 may be a network that supports both 4G and 5G technologies and may include components (described in more detail below) that are configured to support both 4G and 5G technologies. In examples, the 4G and 5G capabilities described for a particular component or function herein may be implemented in a single component, device, and/or function configured to perform both 4G and 5G operations. Alternatively or additionally, the 4G and 5G capabilities described for a particular component or function herein may be implemented in two or more distinct components, devices, and/or functions that may each be configured to perform 4G or 5G operations. In the various examples described herein, different functions and components may be distinctly described (e.g., 4G functions, 5G functions, 4G components, 5G components, etc.). Such functions and components may be implemented using distinct physical and/or virtual resources and/or may be implemented on physical and/or virtual resources that support various distinct functions and components. All such examples are contemplated as within the scope of the instant disclosure.

The environment 100 may include a UE 110 that may wirelessly communicate with a base station 120. The base station 120 represents a 5G gNodeB and/or a 4G eNodeB. In examples, the base station 120 may be a physical base station configured with both eNodeB and gNodeB capabilities and may be referred to as “gNodeB/eNodeB 120.” The gNodeB/eNodeB 120 may communicate with other components and functions in the core network 101. The core network 101 may facilitate communications between particular devices, components, and/or functions of various types in the core of a wireless communications network that may facilitate communication between computing devices and/or mobile devices (e.g., UEs) and/or other systems and devices, such as those accessible via the IMS Core/Internet 170 and/or one or more other data networks (DNs).

Various connections between components and functions in the core network 101 may be wired, wireless, or a combination thereof. The components and functions described herein may be implemented as physical devices, as software components and/or functions executing on one or more computing devices, and as any combination thereof. In various examples, the core network 101 may facilitate the establishment of communications sessions for one or more wireless devices, such as UE 110. In examples, the core network 101 may facilitate authorized packet-based communications between such wireless devices and other wireless devices, devices on the Internet, one or more IMSs, and/or one or more other DNs (e.g., via IMS Core/Internet 170).

In FIG. 1, connections between components and functions may be logical connections that may be facilitated by one or more wired and/or wireless connections and may include traversal of one or more devices, components, and/or functions that may or may not be shown in FIG. 1. The particular interfaces illustrated in FIG. 1 are labeled as 5G/4G interfaces that may be used to facilitate communications between 5G functions and 4G functions, respectively. For example, the UE 110 may communicate with a gNodeB function or component of the gNodeB/eNodeB 120 using the 5G (NR) Uu interface, while the UE 110 may communicate with an eNodeB function or component of the gNodeB/eNodeB 120 using the 4G (LTE) Uu interface.

The core network 101 may include 5G functions, such as an AMF configured at AMF/MME 130, a UDM function configured at UDM/HSS 132, one or more SMFs configured at SMF/SGW-C/PGW-Cs 150 (e.g., SMF/SGW-C/PGW-C 150A-F), and one or more UPFs configured at UPF/SGW-U/PGW-Us 160 (e.g., UPF/SGW-U/PGW-Us 160A-F).

The 5G functions of the core network 101 may communicate with one another using logical and/or physical connections using particular 5G interfaces. For example, the gNodeB function of the gNodeB/eNodeB 120 may exchange communications with the AMF of the AMF/MME 130 using the 5G N1 and/or N2 interfaces. The gNodeB function of the gNodeB/eNodeB 120 may exchange communications with one or more UPFs configured at UPF/SGW-U/PGW-Us 160 (e.g., one or more of UPF/SGW-U/PGW-U 160A-F) using the 5G N3 interface. The AMF of the AMF/MME 130 may exchange communications with the UDM function configured at UDM/HSS 132 using the 5G N8 interface. The AMF of the AMF/MME 130 may exchange communications with one or more SMFs configured at SMF/SGW-C/PGW-Cs 150 (e.g., one or more of SMF/SGW-C/PGW-Cs 150A-F) using the 5G N11 interface. The UDM function configured at UDM/HSS 132 may exchange communications with one or more SMFs configured at SMF/SGW-C/PGW-Cs 150 (e.g., one or more of SMF/SGW-C/PGW-Cs 150A-F) using the 5G N10 interface. One or more SMFs configured at SMF/SGW-C/PGW-Cs 150 (e.g., one or more of SMF/SGW-C/PGW-Cs 150A-F) may exchange communications with any one or more UPFs configured at UPF/SGW-U/PGW-Us 160 (e.g., one or more of UPF/SGW-U/PGW-U 160A-F) using the 5G N4 interface. One or more UPFs configured at UPF/SGW-U/PGW-Us 160 (e.g., one or more of UPF/SGW-U/PGW-U 160A-F) may exchange communications with the IMS Core/Internet 170 using the 5G N5 interface.

The core network 101 may also include 4G functions, such as an MME function configured at AMF/MME 130, an HSS function configured at UDM/HSS 132, one or more SGW-Cs and/or PGW-Cs configured at SMF/SGW-C/PGW-Cs 150 (e.g., SMF/SGW-C/PGW-C 150A-F), and one or more SGW-Us and/or PGW-Us configured at UPF/SGW-U/PGW-Us 160 (e.g., UPF/SGW-U/PGW-U 160A-F).

The 4G functions of the core network 101 may communicate with one another using logical and/or physical connections using particular 4G interfaces. For example, the eNodeB function of the gNodeB/eNodeB 120 may exchange communications with the MME function of the AMF/MME 130 using the 4G S1-CP interface. The eNodeB function of the gNodeB/eNodeB 120 may exchange communications with one or more SGW-Us and/or PGW-Us configured at UPF/SGW-U/PGW-Us 160 (e.g., any one or more of UPF/SGW-U/PGW-U 160A-F) using the 4G S1-UP interface. The MME function of the AMF/MME 130 may exchange communications with the HSS function configured at UDM/HSS 132 using the 4G N8 interface. The MME function of the AMF/MME 130 may exchange communications with one or more SGW-Cs and/or PGW-Cs configured at SMF/SGW-C/PGW-Cs 150 (e.g., any one or more of SMF/SGW-C/PGW-Cs 150A-F) using the 4G S11 interface. The HSS function configured at UDM/HSS 132 may exchange communications with SGW-Cs and/or PGW-Cs configured at SMF/SGW-C/PGW-Cs 150 (e.g., any one or more of SMF/SGW-C/PGW-Cs 150A-F) using the 4G N10 interface. One or more SGW-Cs and/or PGW-Cs configured at SMF/SGW-C/PGW-Cs 150 (e.g., one or more of SMF/SGW-C/PGW-Cs 150A-F) may exchange communications with any one or more SGW-Us and/or PGW-Us configured at UPF/SGW-U/PGW-Us 160 (e.g., one or more of UPF/SGW-U/PGW-U 160A-F) using the 4G S5 and/or S8 interfaces. One or more SGW-Us and/or PGW-Us configured at UPF/SGW-U/PGW-Us 160 (e.g., any one or more of UPF/SGW-U/PGW-U 160A-F) may exchange communications with the IMS Core/Internet 170 using the 4G Gi interface.

In environment 100, the UE 110 may communicate with the eNodeB function of the gNodeB/eNodeB 120 to register with the network and to request the establishment of a communications session (e.g., to communicate with one or more systems via the IMS Core/Internet 170, such as a PDN connection or a PDU session). The eNodeB function of the gNodeB/eNodeB 120 may interact with various components of the core network 101 as described in more detail herein to register the UE 110 and establish a communications session, for example, based on QoS parameters (e.g., associated with a QoS profile associated with the UE 110) that the eNodeB function of the gNodeB/eNodeB 120 may obtain from the HSS function of the UDM/HSS 132 via the MME function of the AMF/MME 130. Among the QoS parameters acquired or otherwise determined for use in establishing a communications session for the UE 110 may be one or more ARP values and one or more QCI values. The eNodeB function of the gNodeB/eNodeB 120 and/or one or more other 4G functions at the core network 101 may use such parameters to configure and establish a tunnel or bearer (e.g., EPS bearer) for the communications session (e.g., between the eNodeB function of the gNodeB/eNodeB 120 and one or more of the SGW-Us and/or PGW-Us configured at UPF/SGW-U/PGW-Us 160).

During the operation of the established communications session, the UE 110 may transmit a handover request to the eNodeB function of the gNodeB/eNodeB 120 requesting to be “handed over” to 5G resources (e.g., of the core network 101). In response to this handover request, the eNodeB function of the gNodeB/eNodeB 120 may forward the handover request to the MME function of the AMF/MME 130 to initiate handover of the UE 110 to the 5G resources. The handover request received from the UE 110 and/or transmitted by the eNodeB function of the gNodeB/eNodeB 120 to the MME function of the AMF/MME 130 may include information that identifies the UE 110 and, in some examples, data associated with the currently operational communications session (e.g., EPS bearer), such as a QoS profile and/or QoS parameters. For example, the handover request may include information that may cause the MME function of the AMF/MME 130 to provide the handover request and/or a corresponding relocation request to the AMF of the AMF/MME 130.

The AMF of the AMF/MME 130 may configure or communicate with one or more 5G SMFs of the SMF/SGW-C/PGW-Cs 150 to establish a 5G communications connection for the UE 110 using the information associated with the handover/relocation request. The SMF(s) of the SMF/SGW-C/PGW-Cs 150 may interact with one or more UPFs of the UPF/SGW-U/PGW-Us 160 to establish the 5G communications session to be used to continue the user communications that were or are currently being facilitated using the 4G bearer or tunnel and 4G functions of the core network 101. In examples, to facilitate such a 5G communications session, an SMF of the SMF/SGW-C/PGW-Cs 150 may configure or otherwise establish a 5G bearer or tunnel (e.g., a 5G flow) between the UE 110 and a UPF of the UPF/SGW-U/PGW-Us 160 that connects to the IMS Core/Internet 170 based on the QoS profile and or parameters associated with the counterpart 4G bearer or tunnel (e.g., indicated by the AMF of the AMF/MME 130 to the SMF of the SMF/SGW-C/PGW-Cs 150).

For example, as described herein, in establishing the 5G communications session, particular QoS data and/or parameters may be evaluated by the SMF of the SMF/SGW-C/PGW-Cs 150 to determine whether to obtain one or more updated QoS parameters for the 5G communications session (e.g., for the 5G flow to be established). If one or more QoS parameters are associated with a requirement for updated QoS parameters, the SMF of the SMF/SGW-C/PGW-Cs 150 may then query the UDM function of the UDM/HSS 132 for one or more QoS parameters associated with the UE 110 and/or its 5G communications session(s).

In various examples, if the SMF of the SMF/SGW-C/PGW-Cs 150 attempting to establish a 5G communications session for the UE 110 determines that the ARP value of the QoS parameters or profile (e.g., as determined based on the handover request or otherwise indicated by the AMF of the AMF/MME 130) is within a set of one or more ARP values associated with an elevated priority device or service, the SMF of the SMF/SGW-C/PGW-Cs 150 may query the UDM function of the UDM/HSS 132 for updated QoS parameters. For instance, ARP values of 2, 3, and/or 4 may be associated with elevated priority service and ARP values of 8 and/or 9 may be associated with standard priority service. In such examples, if the SMF of the SMF/SGW-C/PGW-Cs 150 determines that the associated ARP value(s) is 2, 3, and/or 4, the SMF may query the UDM function of the UDM/HSS 132 for QoS parameters, such a QCI/5QI for the UE 110 and/or its associated communications session. In some such examples, the SMF may query the UDM function of the UDM/HSS 132 for any available 5G QoS parameters, while in other examples the SMF may query the UDM function of the UDM/HSS 132 for particular 5G QoS parameters, such a 5QI.

If the SMF of the SMF/SGW-C/PGW-Cs 150 determines (e.g., based on the ARP value, such as an ARP value of 2, 3, or 4) and acquires one or more updated 5G QoS parameters, the SMF may then configure the 5G flow for the communications session using these updated one or more parameters. For example, the SMF may configure a 5G flow for the communications session using an updated QCI/5QI value that is different from the QCI value that is associated with the counterpart 4G bearer or tunnel. Otherwise, if the SMF of the SMF/SGW-C/PGW-Cs 150 determines that there is no requirement to determine updated 5G QoS parameters (e.g., based on the ARP value, such as an ARP value of 8 or 9), the SMF may configure the 5G flow for the communications session using the parameters associated with the handover and/or standard service parameters (e.g., default QoS parameters for the 5G network and/or the same QoS values there were used with the counterpart 4G bearer or tunnel) without interacting with the UDM, thereby preventing unnecessary control signaling within the 5G network. The SMF of the SMF/SGW-C/PGW-Cs 150 may configure this 5G flow between the gNodeB function of the gNodeB/eNodeB 120 and one or more of the UPFs of the UPF/SGW-U/PGW-Us 160.

The user data exchanged between the UE 110 and the IMS Core/Internet 170 may now be migrated to the newly established 5G flow, with the UE 110 now communicating with the one or more UPFs of the UPF/SGW-U/PGW-Us 160 via the gNodeB function of the gNodeB/eNodeB 120.

### Illustrative Functions and Communications

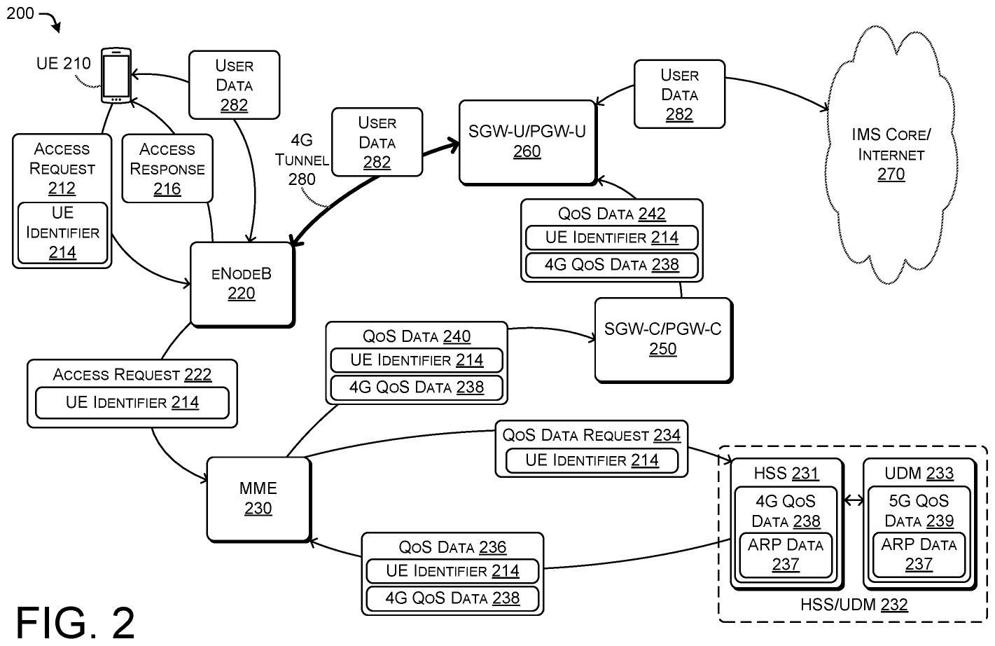

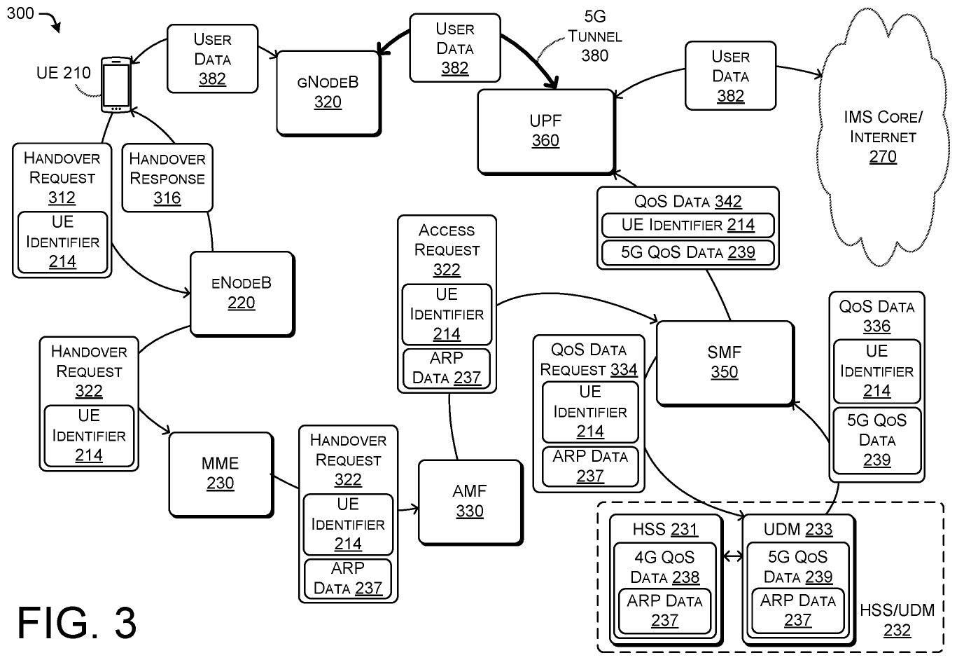

FIGS. 2 and 3 illustrate schematic diagrams of exemplary functions and communications of various messages that may be exchanged in one or more of the disclosed systems and techniques for determining and configuring QoS parameters during handover as described herein. Reference may be made in this description of the exemplary functions and communications to devices, messages, functions, components, and/or operations illustrated in FIG. 1 and described in regard to that figure. However, the functions and communications illustrated in FIGS. 2 and 3 and described herein may be implemented in any suitable system and/or with any one or more suitable devices and/or entities. Moreover, any of the functions and communications described in regard to FIGS. 2 and 3 may be used separately and/or in conjunction with other functions and communications and/or implemented using devices, systems, and or operations. All such embodiments are contemplated as within the scope of the instant disclosure.

FIG. 2 illustrates schematic diagram 200 that may represent a subset of the functions and components similar to those represented in environment 100 of FIG. 1. In this example, a UE 210 may transmit an access request 212 to a 4G eNodeB 220 requesting network registration and/or the establishment of a communications session. The access request 212 may include an indication of a UE identifier 214. The eNodeB 220, in response to the access request 212, may transmit an access request 222 to a 4G MME 230 requesting registration and/or the establishment of a communications session for the UE 210. The access request 222 may indicate the UE identifier 214. The access request 222 may be a relay of the access request 212 or a distinct access request generated by the eNodeB 220 in response to receiving the access request 212 from the UE 210.

In response to the network access request 121, the MME 230 may transmit a QoS data request 234 to the 4G HSS 231 of HSS/UDM component 232 requesting 4G QoS data for the UE 210. The HSS 231 function of the HSS/UDM component 232 may be configured with 4G QoS data 238 for the UE 210 (e.g., during initial provisioning and/or other configuring of the HSS 231) that may include ARP data 237 that may include one or more ARP values. The UDM 233 function of the HSS/UDM component 232 may be similarly configured with 5G QoS data 239 for the UE 210 (e.g., during initial provisioning and/or other configuring of the UDM 233) that may include ARP data 237 that may include one or more ARP values. In examples, the ARP data 237 may be the same for both the 4G QoS data 238 and the 5G QoS data 239, while other QoS data, such as one or more QCI values, may be different in the 4G QoS data 238 and the 5G QoS data 239.

The QoS data request 234 may be a dedicated QoS data request message or may be any other type of message that may be exchanged between the MME 230 and the HSS 231 that may cause the HSS 231 to transmit QoS data 236 for the UE 210 to the MME 230. The QoS data message 236 may include 4G QoS data 238 that may include one or more ARP values indicated in the ARP data 237, one or more QCI values, and/or any other QoS data, as well as an identifier of the UE 214.

The MME 230 may use the 4G QoS data 238 to establish a communications session (e.g., bearer or tunnel (e.g., EPS bearer)) to support communications between the UE 210 and one or more remote devices, for example, via an IMS Core/Internet 270. For example, the MME 230 may provide QoS information for the UE in QoS data 240 that may include the 4G QoS data 238 and the UE identifier 214 to an SGW-C/PGW-C 250 (representing one or more 4G SGW-Cs and/or one or more 4G PGW-Cs). The SGW-C/PGW-C 250 may use this information to control and/or configure an SGW-U/PGW-U 260 (representing one or more 4G SGW-Us and/or one or more 4G PGW-Us) to facilitate communications sessions for the UE 210, for example, by providing the 4G QoS data 238 and the UE identifier 214 to the SGW-U/PGW-U 260 in QoS data 242. The message 242 may be a dedicated QoS data message or one or more messages of any type that may include an indication of the 4G QoS data 238 and its association with the UE 210.

The SGW-U/PGW-U 260 may establish or be configured (e.g., by the SGW-C/PGW-C 250) to provide a 4G communications session, tunnel, or bearer for the UE 210 between the eNodeB 220 and the SGW-U/PGW-U 260, such as 4G tunnel 280. The tunnel 280 may be configured and operated based on the QoS data 238. The eNodeB 220 may transmit an access response 216 that may indicate to the UE 210 that the UE 210 has been successfully registered with the network and/or that a communications session (e.g., using the 4G tunnel 280) has been successfully established for the UE 210.

The UE 210 may then exchange user data 282 with the eNodeB 220. The eNodeB 220 may exchange the user data 282 associated with the UE 210 with the SGW-U/PGW-U 260 via the tunnel 280. The SGW-U/PGW-U 260 may further exchange the user data 282 with the IMS Core/Internet 270.

FIG. 3 illustrates schematic diagram 300 that may represent a subset of the functions and components represented in diagram 200 of FIG. 2, and similar to those represented in environment 100 of FIG. 1. In this example, the UE 210 may initiate a handover from the 4G network and/or technology associated with the eNodeB 220 to 5G network and/or technology associated with a gNodeB 320. For example, the UE 210 may request handover to a 5G gNodeB base station configured at a 5G network via the 4G eNodeB 220 with which it is currently communicating. The UE 210 may perform this operation in response to detecting the 5G gNodeB 320 and/or in response to determining that connectivity characteristics (e.g., potential throughput, available bandwidth, congestion, etc.) associated with the 5G gNodeB 320 are superior to those associated with the 4G eNodeB 220.

To initiate this handover, the UE may transmit a handover request 312 that may include the UE identifier 214 to the eNodeB 220. The eNodeB 220 may forward this request 312 as a handover request 322 (in examples, also including a UE identifier 214) to the MME 230 and/or generate and transmit the handover request 322 to the MME 230 based on the handover request 312. The MME 230 may relay or otherwise transmit the handover request 322 to a 5G AMF 330. Besides identifying the UE, the request 322 may also identify the currently operational communications session (e.g., 4G tunnel, bearer, etc.) and related QoS profile or data. For instance, the handover request 322 may include the ARP data 237 and/or data that may allow the AMF 330 to determine the ARP data 237. Alternatively, the MME 230 and/or the AMF 330 may determine information associated with the UE and/or its communications sessions using other means (e.g., based on the UE identifier 214).

The AMF 330 may configure or communicate with a 5G SMF 350 to establish a 5G communications session using the information associated with the handover request 322. For example, the AMF 330 may transmit an access request 322 that includes the UE identifier 214 to the SMF 350. The access request 322 may also include QoS information for the UE 210, such as the ARP data 237, and/or data that may be used by the SMF 350 to determine QoS information for the UE 210, like the ARP data 237. The SMF 350 may evaluate one or more of the QoS parameters (e.g., an ARP value indicated by the ARP data 237) associated with the access request 322 and/or the UE 210 to determine whether to obtain one or more updated 5G QoS parameters (e.g., a QCI value) for the UE 210, for example, for establishing a 5G flow for a communications session for the UE 210. If one or more QoS parameters (e.g., ARP value(s)) are associated with a requirement for updated 5G QoS parameters, the SMF 350 may then query the UDM 233 with a QoS data request 334 (that may include the UE identifier 214 and/or the ARP data 237) requesting one or more (e.g., updated) 5G QoS parameters associated with the UE 210 and/or its communications session on the 5G network.

For example, the SMF 350 may determine whether the ARP value associated with the UE (e.g., indicated in or determined based on the access request 322 and/or the ARP data 237) is within a set of one or more ARP values associated with an elevated priority device or service. For example, ARP values of 2, 3, and/or 4 may be associated with elevated priority service, while ARP values of 8 and/or 9 may be associated with standard priority service. The SMF 350 may, upon determining that the UE is associated with QoS parameters that include an ARP value of 2, 3, and/or 4, query the UDM 233 via the QoS data request 334 for QoS parameters for the UE 210 and/or associated with ARP values represented in the ARP data 237. The UDM 233 may respond to the request 334 with a QoS data message 336 that may include 5G QoS data 239 (and, in examples, an identifier 214 of the UE 210). The 5G QoS data 239 may include updated QoS data that differs from the 4G QoS data 238 used for the UE 210 in the 4G functions. For example, the 5G QoS data 239 may include a different QCI value than the 4G QoS data 238 but may include the same ARP values represented by the ARP data 237.

The UDM 233 may be configured to determine 5G QoS values based on a UE identifier and/or an ARP value. For example, the UDM 233 may be configured with data mapping QoS values and/or profiles (e.g., data representing QCI/5QI) to UE identifiers and may use this mapping to determine 5G QoS parameters for a particular UE identifier. Alternatively or additionally, the UDM 233 may be configured with data mapping QoS values and/or profiles (e.g., data representing QCI/5QI) to ARP values and may use this mapping to determine 5G QoS parameters for a particular ARP value. In another example, the UDM 233 may be configured with both data mapping QoS values and/or profiles (e.g., data representing QCI/5QI) to UE identifiers and data mapping QoS values and/or profiles (e.g., data representing QCI/5QI) to ARP values. The UDM may use these mappings to determine an ARP value for a particular UE identifier and then use this determined ARP value to determine other 5G QoS parameters, like QCI, for that particular ARP value.

If the SMF 350 determines and acquires one or more updated 5G QoS parameters, the SMF 350 may provide the updated parameters in QoS data message 342 to a 5G UPF 360. The QoS data message 342 may include an identifier 214 of the UE 210 and the 5G QoS data 239. The QoS data message 342 may include an instruction to establish a 5G tunnel 380 (e.g., 5G flow) for user traffic associated with the UE 210. In response to the message 342, the UPF 360 may establish a 5G tunnel 380 (e.g., 5G flow) for exchanging user traffic associated with the UE 210 with a 5G gNodeB 320.

If the SMF 350 determines that there is no requirement to determine updated 5G QoS parameters (e.g., based on the ARP value, such as an ARP value of 8 or 9), the SMF 350 may instruct the UPF 360 to configure a 5G flow (5G tunnel 380) for the communications session using the parameters associated with the handover and/or standard service parameters (e.g., default QoS parameters for the 5G network) without interacting with the UDM 233, thereby preventing unnecessary control signaling within the 5G network.

The eNodeB 220 may transmit a handover response message 216 to the UE 210 indicating the status of the handover requested by the UE 210. In a successful handover, the UE 210 may then exchange user data 382 with the gNodeB 320. The gNodeB 320 may exchange the user data 382 associated with the UE 210 with the UPF 360 via the tunnel 380. The UPF 360 may further exchange the user data 282 with the IMS Core/Internet 270.

### Illustrative Operations

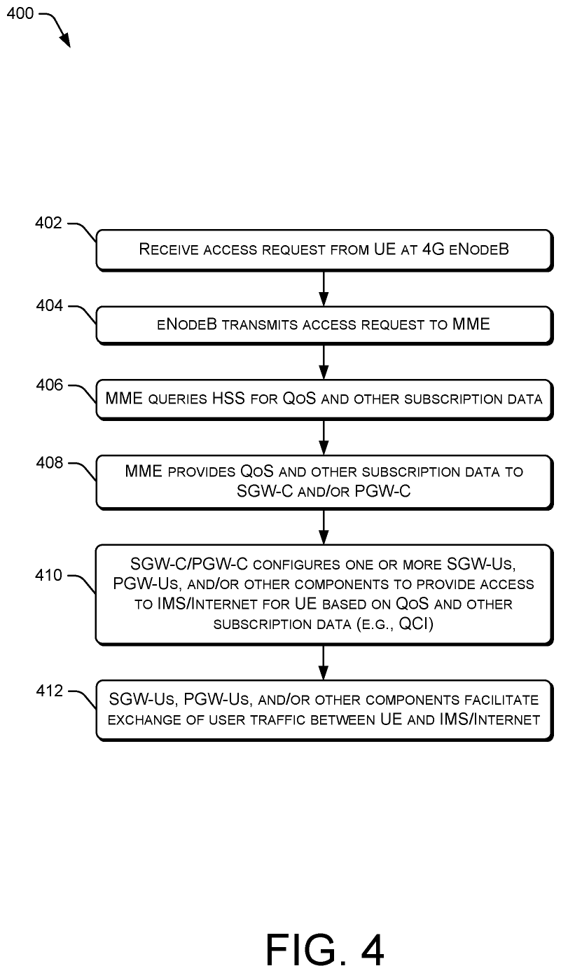

FIG. 4 shows a flow diagram of an illustrative process 400 for establishing communications for a UE with a 4G network according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1 and the example signals and functions of FIGS. 2 and 3; however, other environments, signals, and functions may also be used.

At operation 402, a 4G eNodeB may receive an access request from a UE requesting registration and/or establishment of a communications session at the 4G network at which the eNodeB is configured.

At operation 404, the eNodeB may relay this access request to an MME in the 4G network or otherwise generate and transmit an access request on behalf of the UE to the MME based on the access request received from the UE.

At operation 406, the MME may query a 4G HSS for 4G QoS data and/or other subscription data associated with the UE. This HSS may be configured with such data at the initial provisioning of service for the UE, during account setup and/or device setup, etc., and may be so configured manually and/or automatically via any one or more network components or functions, including those described herein. In examples, the MME may transmit a QoS data request (e.g., a dedicated QoS data request or a message representing a QoS data request) that identifies the UE to the HSS requesting QoS data for the UE. The HSS may, in response to this query and further at operation 406, provide 4G QoS data for the UE, for example as a QoS profile or otherwise as any type of data that may identify, represent, or otherwise indicate 4G QoS data for the UE. This 4G QoS data may include, for example, ARP data (e.g., one or more ARP parameter values) and/or QCI data (e.g., one or more QCI parameter values).

At operation 408, the MME may provide or otherwise use the 4G QoS data to establish a communications session (e.g., bearer or tunnel, such as an EPS bearer) to support communications between the UE and one or more remote devices, for example, via an IMS Core or the Internet. For example, the MME may provide the 4G QoS data to an SGW-C and/or a PGW-C to control and/or cause such a gateway control function to configure an SGW-U and/or a PGW-U to facilitate a communications sessions for the UE. For example, the MME may transmit one or more instructions to one or more 4G control functions instructions such function(s) to establish a bearer for a UE based on the QoS data accompanying the instruction(s).

At operation 410, the SGW-C and/or a PGW-C may configure or otherwise control one or more SGW-Us and/or PGW-Us to facilitate access for the UE based on the QoS data. For example, at operation 410, the SGW-C and/or a PGW-C may configure or otherwise control one or more SGW-Us and/or PGW-Us to configure or otherwise establish a communications session (e.g., bearer or tunnel, such as an EPS bearer) for the UE between the eNodeB and the one or more SGW-Us and/or PGW-Us based on the 4G QoS data.

At operation 412, the user plane control functions, such as the one or more SGW-Us and/or PGW-Us controlled at operation 410, may facilitate user data exchange between the UE and one or more remote devices or systems, for example using the 4G bearer established by such user plane functions under control of one or more control plane functions and configured between the eNodeB and the one or more user plane functions. 220.

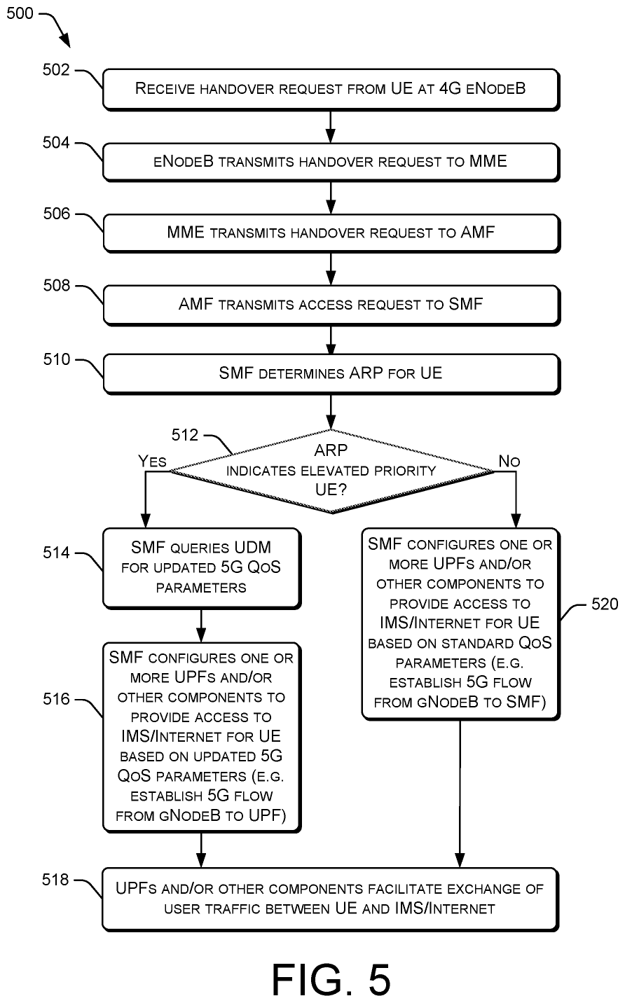

FIG. 5 shows a flow diagram of an illustrative process 500 for determining QoS parameters during handover of a UE from a 4G network and/or component(s) to a 5G network and/or component(s) according to the disclosed embodiments. The process 500 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1 and the example signals and functions of FIGS. 2 and 3; however, other environments, signals, and functions may also be used.

At operation 502, a 4G eNodeB may receive a handover request from a UE requesting to be handed over to a 5G gNodeB and/or another network and/or technology. The handover request may indicate a particular 5G gNodeB base station configured at a 5G network. The UE may generate this handover request based on detecting a 5G gNodeB and/or in response to determining that connectivity characteristics (e.g., potential throughput, available bandwidth, congestion, etc.) associated with the 5G gNodeB may be superior to those associated with the 4G eNodeB.

At operation 504, the eNodeB may forward the handover request to a 4G MME and/or generate and transmit a corresponding handover request on behalf of the UE to the MME based on the handover request received by the eNodeB. The handover request may include data indicating or representing the UE and/or any other data that may be used to facilitate one or more handover operations.

At operation 506, the MME may forward the handover request to a 5G AMF and/or generate and transmit a corresponding handover request to the AMF based on the handover request received by the MME. In examples, the MME may generate this request for the AMF to include at least ARP data (e.g., one or more ARP values) and/or data representing or indicating one or more ARP values. The request generated by the MME may also, or instead, identify the UE. The request may also identify the currently operational communications session (e.g., 4G tunnel, bearer, etc.) and any other data associated with the UE and/or its configuration on the 4G network. Alternatively, at operation 506, in response to the request, the AMF may determine information associated with the UE and/or its communications sessions using other means (e.g., based on a UE identifier in the request).

At operation 508, in response to the handover request received at operation 506, the AMF may configure or communicate with a 5G SMF to initiate the establishment of a 5G communications session for the UE. using the information associated with the handover request 322. For example, the AMF may transmit an access request to the SMF that includes or indicates a UE identifier and/or one or more ARP values. The access request may also, or instead, include data that allows the SMF to determine the UE identifier and/or one or more ARP values. At operation 510, the SMF may determine this ARP value for the UE based on the access request received from the AMF.

At operation 512, the SMF may evaluate one or more of the QoS parameters associated with the UE, such as the determined ARP value from operation 510, to determine whether it is associated with an elevated priority UE. If the SMF determines that an ARP value associated with the UE indicates that the UE is an elevated priority UE, the SMF may determine that updated 5G QoS parameters should be used to establish a 5G communications session for the UE.

If, at operation 512, the SMF determines that updated 5G QoS are needed to establish a 5G communication session for the UE, at operation 514, the SMF may query a 5G UDM for 5G QoS parameters associated with the UE and/or the ARP value. For example, the SMF may request QoS parameters associated with the UE identifier from the UDM. Alternatively or additionally, the SMF may request QoS parameters associated with the ARP value from the UDM. For example, the SMF may determine at operation 512 that an ARP value associated with the UE is within a set of one or more ARP values associated with an elevated priority device or service, such as the set of ARP values of 2, 3, and/or 4. In response, at operation 514, the SMF may query the UDM for 5G QoS data for the UE and/or the corresponding ARP value. The UDM may respond with 5G QoS data that may include a QCI/5QI that is different from that associated with the UE on a 4G network. ARP value used by the UE on the 4G and 5G networks may be the same and, therefore, the UDM may or may not provide such an ARP value to the SMF. In examples, the UDM may provide the QoS profile, which may contain or otherwise indicate a (e.g., complete) set of QoS parameters for the UE.

At operation 516, the SMF may control, configure, or instruct one or more 5G UPFs to establish a 5G tunnel (e.g., 5G flow) for user traffic associated with the UE based on the 5G QoS data determined at operation 514. In response to such control or instructions, the one or more UPFs may establish one or more 5G tunnels (e.g., 5G flows) between the gNodeB and the one or more UPFs for exchanging user traffic associated with the UE. At operation 518, the UPFs and/or other 5G components and/or functions may facilitate the exchange of user data associated with the UE using 5G resources.

If, at operation 512, the SMF determines that the ARP value associated with the UE is not an elevated service ARP, and, therefore, that updated 5G QoS data is not needed to establish a 5G communication session for the UE, at operation 520, the SMF may instruct one or more UPFs to establish a 5G tunnel (e.g., 5G flow) for user traffic associated with the UE based on the default or standard QoS data and/or based on QoS data determined at operation 506 or 508 (e.g., determined based on the handover request and/or access request and determined without interacting with a UDM). In response to such control or instructions, the one or more UPFs may establish one or more 5G tunnels (e.g., 5G flows) between the gNodeB and the one or more UPFs for exchanging user traffic associated with the UE. At operation 518, the UPFs and/or other 5G components and/or functions may facilitate the exchange of user data associated with the UE using 5G resources.

Note that any of the operations performed in the processes 400 and 500 may be combined, along with any other operations or functions described herein. Any combinations of operations are contemplated as within the scope of the instant disclosure.

In summary, by more efficiently determining whether to obtain updated QoS parameters during handover, the disclosed systems and techniques may be able to increase the efficiency of usage of core network resources and other wireless network resources and improve the performance of both the network and user devices, especially for elevated priority users and services.

### Example User Equipment

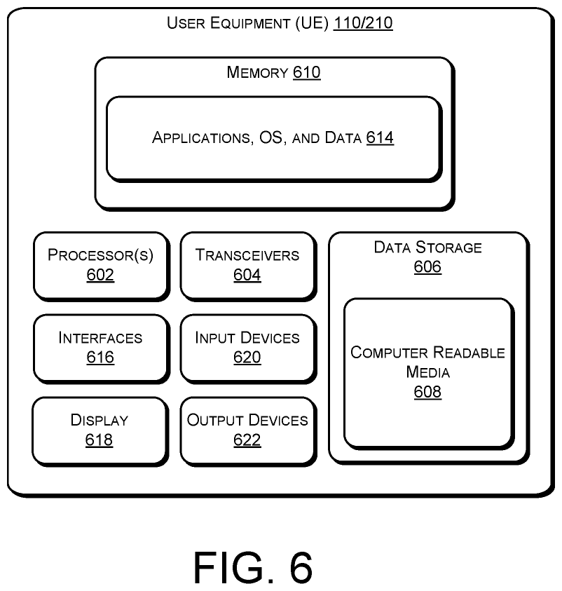

FIG. 6 is an example of a UE, such as UEs 110 and 210, for use with the systems and methods disclosed herein, in accordance with some examples of the present disclosure. The UE 110/210 may include one or more processors 602, one or more transmit/receive antennas (e.g., transceivers or transceiver antennas) 604, and a data storage 606. The data storage 606 may include a computer-readable media 608 in the form of memory and/or cache. This computer-readable media may include a non-transitory computer-readable media. The processor(s) 602 may be configured to execute instructions, which can be stored in the computer-readable media 608 and/or in other computer-readable media accessible to the processor(s) 602. In some configurations, the processor(s) 602 is a Central Processing Unit (CPU), a Graphics Processing Unit (GPU), or both CPU and GPU, or any other sort of processing unit. The transceiver antenna(s) 604 can exchange signals with a base station, such as eNodeB/gNodeB 120, eNodeB 220, and/or gNodeB 320.

The UE 110/210 may be configured with a memory 610. The memory 610 may be implemented within, or separate from, the data storage 606 and/or the computer-readable media 608. The memory 610 may include any available physical media accessible by a computing device to implement the instructions stored thereon. For example, the memory 610 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110/210.

The memory 610 can store several modules, such as instructions, data stores, and so forth that are configured to execute on the processor(s) 602. In configurations, the memory 610 may also store one or more applications 614 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., eNodeB/gNodeB 120, eNodeB 220, and/or gNodeB 320). The applications 614 may also include one or more operating systems and/or one or more third-party applications that provide additional functionality to the UE 110/210. The memory may also, or instead, store QoS information, bandwidth information, such as UE-supported bands, bandwidth(s) and bandwidth parts, as well as communications session information such as UE-specific carrier bandwidth(s). The memory may also, or instead, store permit list and/or block list information, PDN-Type information, SMF information, UPF information, NRF information, etc.

Although not all illustrated in FIG. 6, the UE 110/210 may also comprise various other components, e.g., a battery, a charging unit, one or more network interfaces 616, an audio interface, a display 618, a keypad or keyboard, and one or more input devices 620, and one or more output devices 622.

### Example Computing Device

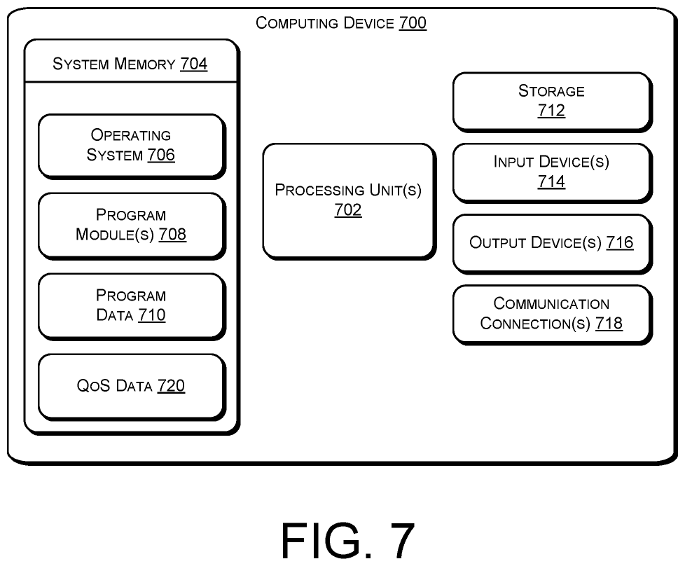

FIG. 7 is an example of a computing device 700 for use with the systems and methods disclosed herein, in accordance with some examples of the present disclosure. The computing device 700 can be used to implement various components of a core network, a base station (e.g., eNodeB/gNodeB 120, eNodeB 220, gNodeB 320), any one or more components in a wireless communications network (e.g., AMF/MME 130, HSS/UDM 132, any of SMF/SGW-C/PGW-Cs 150, any of UPF/SGW-U/PGW-Us 160, any other component illustrated in FIGS. 2 and 3), and/or any servers, routers, gateways, gateway elements, administrative components, etc. that can be used by a communication provider. One or more computing devices 700 can be used to implement the core network 101, for example. One or more computing devices 700 can also be used to implement base stations and other components.

In various embodiments, the computing device 700 can include one or more processing units 702 and system memory 704. Depending on the exact configuration and type of computing device, the system memory 704 can be volatile (such as RAM), nonvolatile (such as ROM, flash memory, etc.) or some combination of the two. The system memory 704 can include an operating system 706, one or more program modules 708, program data 710, and QoS data 720. The system memory 704 may be secure storage or at least a portion of the system memory 704 can include secure storage. The secure storage can prevent unauthorized access to data stored in the secure storage. For example, data stored in the secure storage can be encrypted or accessed via a security key and/or password.

The computing device 700 can also include additional data storage devices (removable and/or non-removable) such as, for example, magnetic disks, optical disks, or tape. Such additional storage is illustrated in FIG. 7 by storage 712.

The computing device 700 may store, in either or both of the system memory 704 and the storage 712, QoS information, block list information, permit list information, associated functions, timer information and/or timestamps, message transfer data, PDU session information, SMF data, etc.

Non-transitory computer storage media of the computing device 700 can include volatile and nonvolatile, removable and non-removable media implemented in any method or technology for storage of information, such as computer-readable instructions, data structures, program modules, or other data. The system memory 704 and storage 712 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 700. Any such non-transitory computer-readable storage media can be part of the computing device 700.

In various embodiments, any or all of the system memory 704 and storage 712 can store programming instructions which, when executed, implement some or all of the functionality described above as being implemented by one or more systems configured in the environment 100 and/or components of the network 101, functions illustrated in the diagram 200, and/or functions illustrated in the diagram 300.

The computing device 700 can also have one or more input devices 714, such as a keyboard, a mouse, a touch-sensitive display, voice input device, etc. The computing device 700 can also have one or more output devices 716 such as a display, speakers, a printer, etc. can also be included. The computing device 700 can also contain one or more communication connections 718 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.

A: A method performed by a one or more computing devices configured in a wireless communications network, the method comprising: receiving, at a 5G session management function (SMF), a request to establish a 5G communications session for a user equipment (UE); determining, at the 5G SMF based at least in part on the request, an allocation and retention priority (ARP) value associated with the UE; determining, at the 5G SMF based at least in part on the ARP value, to acquire 5G quality of service (QoS) data for the UE; querying, by the 5G SMF, a 5G unified data management (UDM) function for the 5G QoS data; and transmitting, from the 5G SMF to a 5G user plane function (UPF), an instruction comprising data representing the 5G QoS data and controlling the UPF to establish the 5G communications session based at least in part on the 5G QoS data.

B: The method of paragraph A, wherein determining to acquire the 5G QoS data comprises determining that the ARP value is associated with an elevated priority service.

C: The method of paragraph A or B, wherein determining to acquire the 5G QoS data comprises determining that the ARP value is associated with a wireless priority service (WPS).

D: The method of any of paragraphs A-C, further comprising: receiving, at the 5G SMF, a second request to establish a second 5G communications session for a second UE; determining, at the 5G SMF based at least in part on the second request, a second ARP value associated with the second UE; determining, at the 5G SMF based at least in part on the second ARP value, to establish the second 5G communications session independent of querying the 5G UDM; and transmitting, from the 5G SMF to a second 5G UPF, a second instruction controlling the second UPF to establish the second 5G communications session.

E: The method of paragraph D, wherein the second instruction controls the second UPF to establish the second 5G communications session using default QoS data.

F: The method of paragraph D or E, wherein the second instruction controls the second UPF to establish the second 5G communications session using QoS data determined based at least in part on the second request.

G: A network computing device configured at a wireless communications network, the network computing device comprising: one or more processors; one or more transceivers; and non-transitory computer-readable media storing computer-executable instructions that, when executed by the one or more processors, cause the one or more processors to execute a session management function to perform operations comprising: receiving a request to establish a 5G communications session for a user equipment (UE); determining, based at least in part on the request, a quality of service (QoS) parameter value associated with the UE; determining, based at least in part on the QoS parameter value, to acquire one or more updated QoS parameter values for the UE; querying a 5G unified data management (UDM) function for the one or more updated QoS parameter values; and transmitting, to a 5G user plane function (UPF), an instruction comprising data representing the one or more updated QoS parameter values and controlling the UPF to establish the 5G communications session based at least in part on the one or more updated QoS parameter values.

H: The network computing device of paragraph G, wherein the one or more updated QoS parameter values comprise a QoS class identifier (QCI).

I: The network computing device of paragraph G or H, wherein the request to establish the 5G communications session was received from a 5G access and mobility management function (AMF).

J: The network computing device of paragraph I, wherein the request to establish the 5G communications session was generated by the 5G AMF in response to a handover request associated with the UE and received from a 4G mobility management entity (MME).

K: The network computing device of any of paragraphs G-J, wherein: the QoS parameter value comprises an allocation and retention priority (ARP) value; and the one or more updated QoS parameter values comprise the ARP value.

L: The network computing device of any of paragraphs G-K, wherein the QoS parameter value is associated with a wireless priority service (WPS).

M: The network computing device of any of paragraphs G-L, wherein controlling the UPF to establish the 5G communications session comprises controlling the UPF to establish a 5G flow between the UPF and a 5G gNodeB using one or more of the one or more updated QoS parameter values.

N: The network computing device of any of paragraphs G-M, wherein controlling the UPF to establish the 5G communications session comprises configuring the UPF to facilitate an exchange of user data associated with the UE between the UE and an IP multimedia system (IMS).

O: A non-transitory computer-readable media storing computer-executable instructions that, when executed by one or more processors, cause the one or more processors to perform operations comprising: receiving, at a session management function, a request to establish a communications session for a user equipment (UE); determining, at the session management function and based at least in part on the request, a quality of service (QoS) parameter value associated with the UE; determining, at the session management function and based at least in part on the QoS parameter value, to acquire one or more QoS parameter values for the UE; querying, by the session management function, a unified data management function for the one or more QoS parameter values; and transmitting, from the session management function to a user plane function, an instruction comprising data representing the one or more QoS parameter values and controlling the user plane function to establish the communications session based at least in part on the one or more QoS parameter values.

P: The non-transitory computer-readable media of paragraph O, wherein the request comprises the QoS parameter value.

Q: The non-transitory computer-readable media of paragraph O or P, wherein: the request comprises a UE identifier; and determining the QoS parameter value comprises determining the QoS parameter value based at least in part on the UE identifier.

R: The non-transitory computer-readable media of any of paragraphs O-Q, wherein the QoS parameter value comprises a 4G allocation and retention priority (ARP) value.

S: The non-transitory computer-readable media of paragraph R, wherein the one or more QoS parameter values comprise a 5G QoS identifier (5QI).

T: The non-transitory computer-readable media of any of paragraphs O-S, wherein the request is associated with a handover request generated by the UE.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a one or more computing devices configured in a wireless communications network, the method comprising:
receiving, at a 5G session management function (SMF), a request to establish a 5G communications session for a user equipment (UE);
determining, at the 5G SMF based at least in part on the request, an allocation and retention priority (ARP) value associated with the UE;
determining, at the 5G SMF based at least in part on the ARP value, to acquire 5G quality of service (QoS) data for the UE;
querying, by the 5G SMF, a 5G unified data management (UDM) function for the 5G QoS data; and
transmitting, from the 5G SMF to a 5G user plane function (UPF), an instruction comprising data representing the 5G QoS data and controlling the UPF to establish the 5G communications session based at least in part on the 5G QoS data.

2. The method of claim 1, wherein determining to acquire the 5G QoS data comprises determining that the ARP value is associated with an elevated priority service.

3. The method of claim 1, wherein determining to acquire the 5G QoS data comprises determining that the ARP value is associated with a wireless priority service (WPS).

4. The method of claim 1, further comprising:
receiving, at the 5G SMF, a second request to establish a second 5G communications session for a second UE;
determining, at the 5G SMF based at least in part on the second request, a second ARP value associated with the second UE;
determining, at the 5G SMF based at least in part on the second ARP value, to establish the second 5G communications session independent of querying the 5G UDM; and
transmitting, from the 5G SMF to a second 5G UPF, a second instruction controlling the second UPF to establish the second 5G communications session.

5. The method of claim 4, wherein the second instruction controls the second UPF to establish the second 5G communications session using default QoS data.

6. The method of claim 4, wherein the second instruction controls the second UPF to establish the second 5G communications session using QoS data determined based at least in part on the second request.

7. A network computing device configured at a wireless communications network, the network computing device comprising:
one or more processors;
one or more transceivers; and
non-transitory computer-readable media storing computer-executable instructions that, when executed by the one or more processors, cause the one or more processors to execute a session management function to perform operations comprising:
receiving a request to establish a 5G communications session for a user equipment (UE);
determining, based at least in part on the request, a quality of service (QoS) parameter value associated with the UE;
determining, based at least in part on the QoS parameter value, to acquire one or more updated QoS parameter values for the UE;
querying a 5G unified data management (UDM) function for the one or more updated QoS parameter values; and
transmitting, to a 5G user plane function (UPF), an instruction comprising data representing the one or more updated QoS parameter values and controlling the UPF to establish the 5G communications session based at least in part on the one or more updated QoS parameter values.

8. The network computing device of claim 7, wherein the one or more updated QoS parameter values comprise a QoS class identifier (QCI).

9. The network computing device of claim 7, wherein the request to establish the 5G communications session was received from a 5G access and mobility management function (AMF).

10. The network computing device of claim 9, wherein the request to establish the 5G communications session was generated by the 5G AMF in response to a handover request associated with the UE and received from a 4G mobility management entity (MME).

11. The network computing device of claim 7, wherein:
the QoS parameter value comprises an allocation and retention priority (ARP) value; and
the one or more updated QoS parameter values comprise the ARP value.

12. The network computing device of claim 7, wherein the QoS parameter value is associated with a wireless priority service (WPS).

13. The network computing device of claim 7, wherein controlling the UPF to establish the 5G communications session comprises controlling the UPF to establish a 5G flow between the UPF and a 5G gNodeB using one or more of the one or more updated QoS parameter values.

14. The network computing device of claim 7, wherein controlling the UPF to establish the 5G communications session comprises configuring the UPF to facilitate an exchange of user data associated with the UE between the UE and an IP multimedia system (IMS).

15. A non-transitory computer-readable media storing computer-executable instructions that, when executed by one or more processors, cause the one or more processors to perform operations comprising:
receiving, at a session management function, a request to establish a communications session for a user equipment (UE);
determining, at the session management function and based at least in part on the request, a quality of service (QoS) parameter value associated with the UE;
determining, at the session management function and based at least in part on the QoS parameter value, to acquire one or more QoS parameter values for the UE;
querying, by the session management function, a unified data management function for the one or more QoS parameter values; and
transmitting, from the session management function to a user plane function, an instruction comprising data representing the one or more QoS parameter values and controlling the user plane function to establish the communications session based at least in part on the one or more QoS parameter values.

16. The non-transitory computer-readable media of claim 15, wherein the request comprises the QoS parameter value.

17. The non-transitory computer-readable media of claim 15, wherein:
the request comprises a UE identifier; and
determining the QoS parameter value comprises determining the QoS parameter value based at least in part on the UE identifier.

18. The non-transitory computer-readable media of claim 15, wherein the QoS parameter value comprises a 4G allocation and retention priority (ARP) value.

19. The non-transitory computer-readable media of claim 18, wherein the one or more QoS parameter values comprise a 5G QoS identifier (5QI).

20. The non-transitory computer-readable media of claim 15, wherein the request is associated with a handover request generated by the UE.
